(19) United States
(12) Patent Application Publication
(10) Pub. No.: US 2004/0134108 A1
(43) Pub. Date: Jul. 15, 2004

(54) Mounting display device for flags, banners or pennants having magnetic strips thereon for mounting on vehicles and other metal structures

(76) Inventor: Jacob Harari, Brooklyn, NY (US)

Correspondence Address: EZRA SUTTON, P.A., Plaza 9, 900 ROUTE 9, WOODBRIDGE, NJ, 07095, US

(21) Appl. No.: 10/342,742

(22) Filed: Jan. 15, 2003

(51) Int. Cl. G09F 7/04; G09F 21/04

(52) U.S. Cl. 40/600; 40/591

(57) ABSTRACT

A mounting display device for a flag, a banner or a pennant for detachably mounting to a vehicle or other metal structures. The mounting display device includes a flag, a banner or a pennant being referred to as a flag and having a mounting section. The mounting section includes a first mounting side and a second mounting side. The mounting display device further includes a first magnetic member for magnetically attaching to a metal surface of the vehicle or metal surface having a first contact surface and a second contact surface; and a second magnetic member for magnetically attaching to a metal surface of the vehicle or metal structure having a first contact surface and a second contact surface. The first contact surface of the first magnetic member includes adhesive, glue or epoxy cement thereon for adhering to the first mounting side of the mounting section of the flag, respectively; and the first contact surface of the second magnetic member includes adhesive, glue or epoxy cement thereon for adhering to the second mounting side of the mounting section of the flag, respectively. The second contact surfaces of each of the first and second magnetic members are for attaching the flag to a vehicle or a metal structure.

### FIELD OF THE INVENTION

The present invention relates to a mounting display device for flags, banners, pennants, ensigns or pennons having one or more magnetic strips thereon for mounting onto vehicles and other metal structures. More particularly, the magnetic strip(s) is adhesively secured to a mounting section of the flag, etc., and then the magnetic strip may be magnetically attached to the vehicle (or other metallic structures) which then produces a “flying flag” effect when the vehicle is moving so as to provide a display without the use of tape, nails or string when used on a metallic structure, such as a vehicle, metal door or screen door.

### BACKGROUND OF THE INVENTION

Mounting display devices for supporting and displaying of signs, flags, banners, decorative articles and the like on vehicles are well known in the art. These devices have various designs, configurations and structures allowing the device to be attached to the vehicle. Many of these devices have several component parts for the supporting, mounting and attachment of the mounting display device to the vehicle.

There remains a need for a mounting display device for flags, banners, pennants, ensigns or pennons having one or more magnetic strips or bars thereon for mounting onto vehicles or metallic structures. Additionally, the magnetic strip(s) or magnetic bar(s) includes securing means for attaching the magnetic strip(s) or magnetic bar(s) to one or both mounting section surfaces at one end of the flag, banner, etc.

### DESCRIPTION OF THE PRIOR ART

Mounting display devices for supporting and displaying of signs, flags, decorative articles and the like for use with moving vehicles having various designs, configurations, structures and materials of construction have been disclosed in the prior art. For example, U.S. Pat. No. 5,549,939 discloses an ornamental device that is mounted on a vehicle for displaying a fan's sports team preference. A first embodiment includes a molded cap replica of a sports team official cap. A first means for attaching the cap to the vehicle comprises a magnet. A second means for attaching the molded cap to the vehicle is through use of a cord. The cord and magnet may also both be used. The cord is connected to one end of the outer diameter of the molded cap, and subsequently is stretched across the top of the roof, through the interior of the car, then secured to the opposite side of the molded cap. This prior art patent does not teach or disclose the particular structure of a mounting display device having magnetic members thereon for attaching to a vehicle.

U.S. Pat. No. 4,835,024 discloses a decorative article for releaseable attachment to a magnetizable surface, including a base of magnetized sheet material and a projection member attached to the base which serves to hold an ornament on the base in an assembled state. The base is constructed of a flexible, resilient magnetic sheet. The projection member includes a connection member for attaching the projection member to the base and an integral upstanding projection. A sleeve having a head is received onto the upstanding projection. Interposed between the head of the sleeve and the base is an ornament, held in an assembled state by the interaction of the base, the head of the sleeve and the upstanding projection. Apertures are provided in the base to ensure an absence of suction when the base is removed from the magnetizable surface. This prior art patent does not teach or disclose the particular structure of a mounting display device having magnetic members thereon for attaching to a vehicle.

None of the prior art patents disclose or teach a mounting display device having a pair of magnetic members with a flag there between for mounting onto a vehicle or other metal structures.

Accordingly, it is an object of the present invention to provide for a mounting display device for flags, banners, pennants, ensigns, pennons, and the like having magnetic members thereon for mounting on vehicles and other metallic structures.

Another object of the present invention is to provide a mounting display device having each of the magnetic members being attached by securing means to each of the mounting section surfaces at one end of the flag.

Another object of the present invention is to provide a mounting display device that allows the magnetic members to be attached to the mounting section surfaces of the flag by securing means in the form of adhesives, glues, epoxy cements, laser welding, stapling, stitching and fusing or as a lamination in order to make the magnetic member(s) an integral part of the construction.

Another object of the present invention is to provide a mounting display device that allows the stitching of the magnetic member(s) to the flag and/or other types of displays.

Another object of the present invention is to provide a mounting display device that uses a magnetic member(s) in the form of a flexible rubberized magnetic strip(s) or a rigid magnetized bar/strip(s) for attaching to the mounting section surfaces of the flag.

Another object of the present invention is to provide a mounting display device that allows the magnetic members to be magnetically attached to the vehicle which then produces a “flying flag” effect when the vehicle is moving.

Another object of the present invention is to provide a mounting display device of varying sizes, shapes, designs and configuration for use on cars, motorcycles, pick-up trucks, vans, SUVs, buses, tractor trailers, as well as for use on metal doors, ceilings and posts.

Another object of the present invention is to provide a mounting display device is capable of withstanding everyday wear and tear, easy to use and is aesthetically pleasing when mounted to the vehicle or other metal structure as well as eliminating the use of tape, wire or string to display and then remove without leaving marks or mars.

Another object is to use this device as an interchangeable advertising device on vehicles, store fronts, and other metal structures.

A further object of the present invention is to provide a mounting display device that can be mass produced in an automated and economical manner and is readily affordable by the consumer, and used as a device to display their beliefs.

### SUMMARY OF THE INVENTION

In accordance with the present invention, there is provided a mounting display device for a flag, a banner or a pennant for detachably mounting to a vehicle or other metal structures. The mounting display device includes a flag, a banner or a pennant being referred to as a flag and having a mounting section. The mounting section includes a first mounting side and a second mounting side. The mounting display device further includes a first magnetic member for magnetically attaching to a metal surface of the vehicle or metal structure having a first contact surface and a second contact surface; and a second magnetic member for magnetically attaching to a metal surface of the vehicle or metal structure having a first contact surface and a second contact surface. The first contact surface of the first magnetic member includes adhesive, glue or epoxy cement thereon for adhering to the first mounting side of the mounting section of the flag, respectively; and the first contact surface of the second magnetic member includes adhesive, glue or epoxy cement thereon for adhering to the second mounting side of the mounting section of the flag, respectively. The second contact surfaces of each of the first and second magnetic members are for attaching the flag to a vehicle or a metal structure.

### BRIEF DESCRIPTION OF THE DRAWINGS

Further objects, features, and advantages of the present invention will become apparent upon the consideration of the following detailed description of the presently-preferred embodiment when taken in conjunction with the accompanying drawings, wherein:

FIG. 1 is a perspective view of the mounting display device of the first embodiment of the present invention showing the major component parts in an assembled state;

FIG. 1A is a perspective view of the mounting display device of the first embodiment of the present invention showing the device in an assembled state and in an operational mode with the device adhered to a moving van;

FIG. 1B is a perspective view of the mounting display device of the first embodiment of the present invention showing the device in an assembled state and in an operational mode with the device adhered to an automobile;

FIG. 2 is a top plan view of the mounting display device of the first embodiment of the present invention showing a pair of magnetic strips and a flag there between;

FIG. 3 is an exploded perspective view of the mounting display device of the first embodiment of the present invention showing each of the magnetic strips being attached to a pair of mounting side surfaces at one end of the flag;

FIG. 4 is a perspective view of the mounting display device of the second embodiment of the present invention showing a single magnetic strip attached to only one of the mounting side surfaces of a pennant;

FIG. 4A is a perspective view of the mounting display device of the second embodiment of the present invention showing the device in an assembled state and in an operational mode with the device adhered to a football goalpost;

FIG. 4B is a perspective view of the mounting display device of the second embodiment of the present invention showing the device in an assembled state and in an operational mode with the device adhered to a metal fence;

FIG. 5 is a top plan view of the mounting display device of the second embodiment of the present invention showing the magnetic strip attached to one of the sides of the mounting side surfaces of the mounting section at one end of the pennant;

FIG. 6 is a perspective view of the mounting display device of the third embodiment of the present invention showing a single magnetic bar attached to only one of the mounting side surfaces of a banner;

FIG. 6A is a perspective view of the mounting display device of the third embodiment of the present invention showing the device in an assembled state and in operational mode with the device adhered to a facade structure of a bridge;

FIG. 6B is a perspective view of the mounting display device of the third embodiment of the present invention showing the device in an assembled state and in operational mode with the device adhered to a lamppost;

FIG. 7 is a top plan view of the mounting display device of the third embodiment of the present invention showing the magnetic bar attached to one of the sides of the mounting side surfaces of the mounting section at one end of the banner.

### DETAILED DESCRIPTION OF THE EXEMPLARY EMBODIMENTS

### Overview

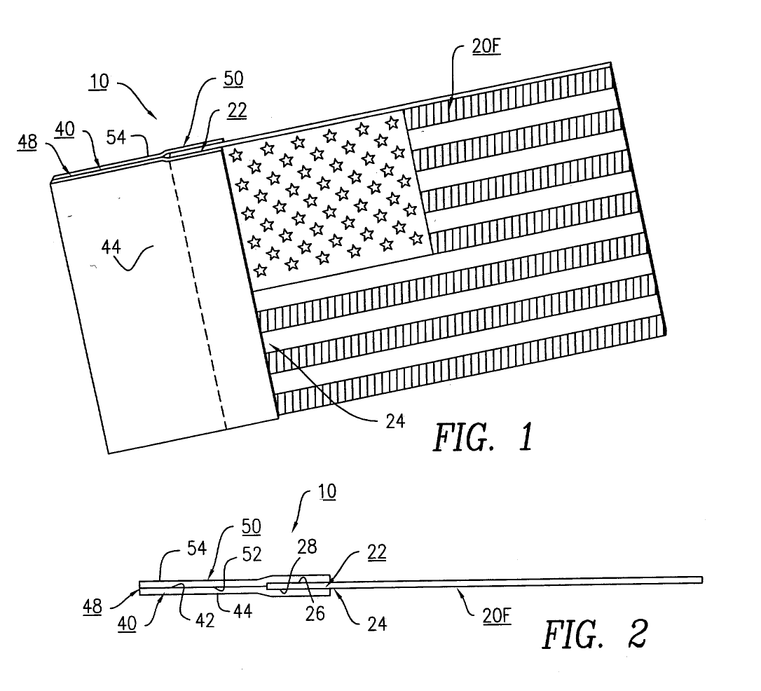

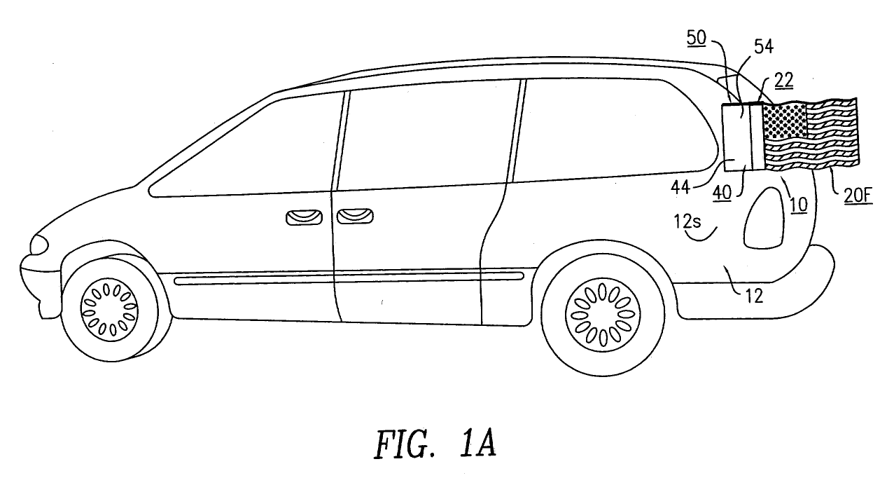

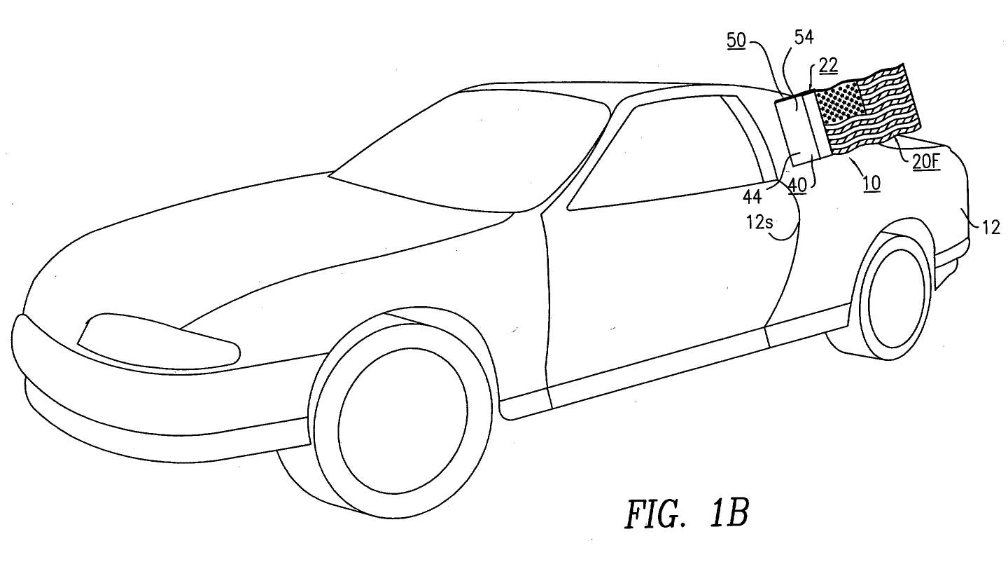

The mounting display devices 10, 100 and 200 for flags 20F, pennants 120P and banners 220B of the first, second and third embodiments, respectively, of the present invention are represented in detail by FIGS. 1 through 7 of the patent drawings. The mounting display device 10 of the first embodiment is mounted to a vehicle 12, such that when the flag 20F is magnetically attached to the vehicle 12, the flag 20F produces a “flying flag” effect when the vehicle 12 is moving, as depicted in FIGS. 1A and 1B of the drawings.

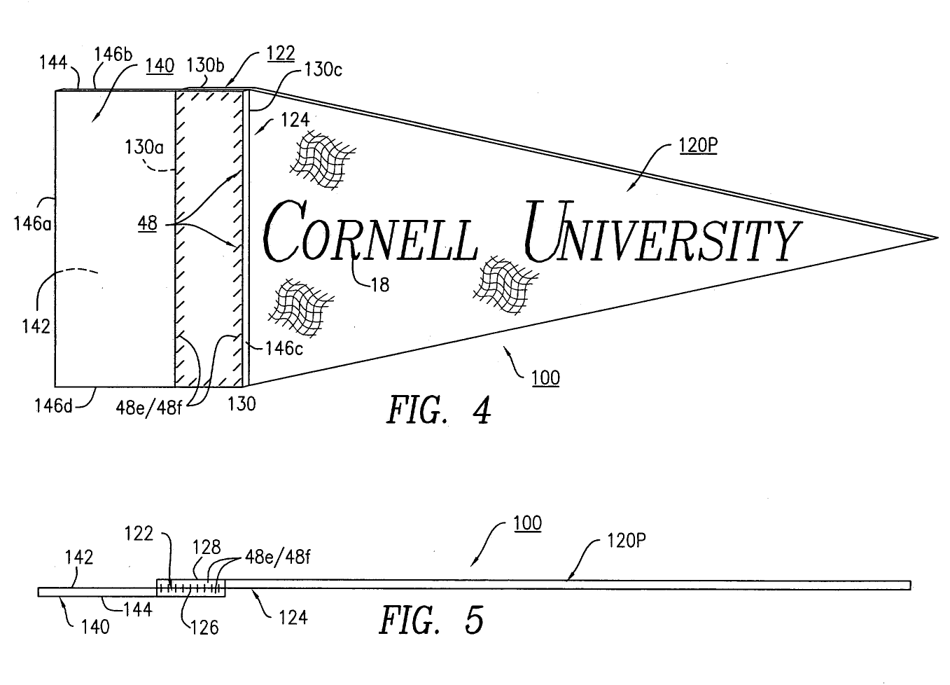

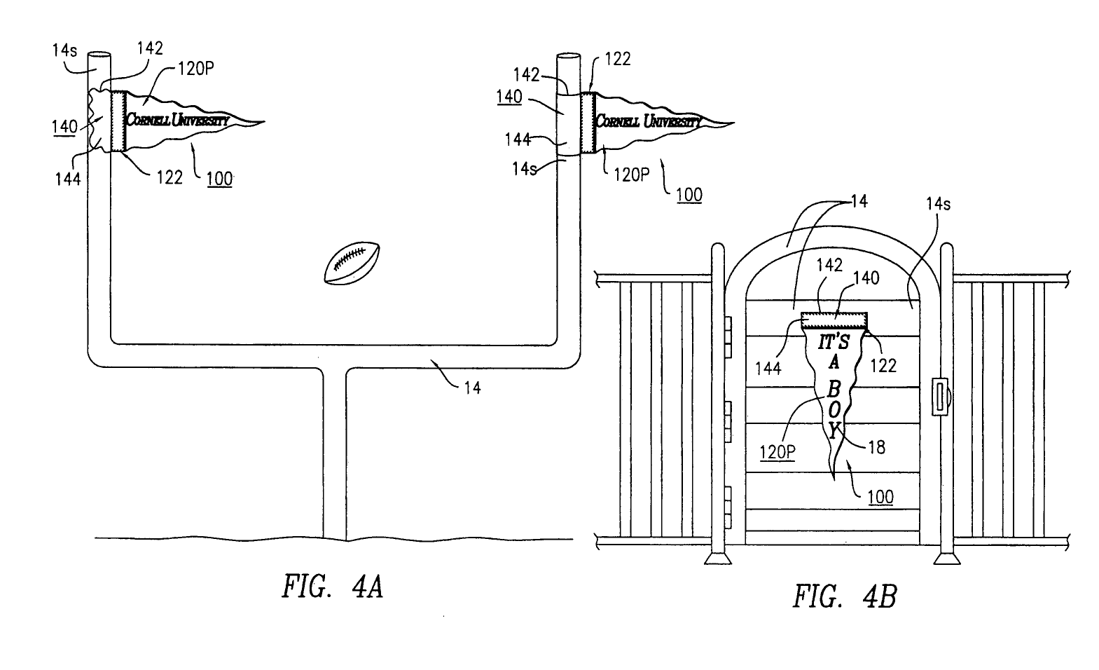

The mounting display device 100 of the second embodiment is mounted to a metal structure 14, for example a football goalpost (see FIG. 4A), a sailboat mast, metal decking or metal fencing (see FIG. 4B), such that when the pennant(s) 120P is magnetically attached to the metal structure 14 the prevailing wind will produce a “flying pennant” effect to the one or more pennants 120P attached to the stationary metal structure 14, as shown in FIG. 4A of the drawings.

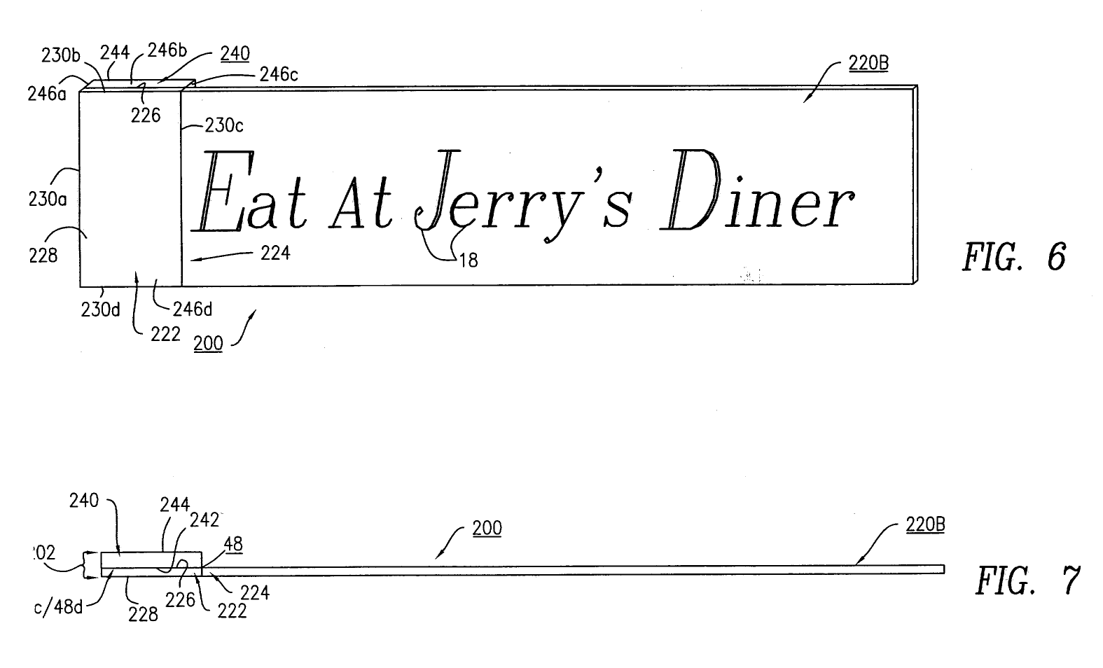

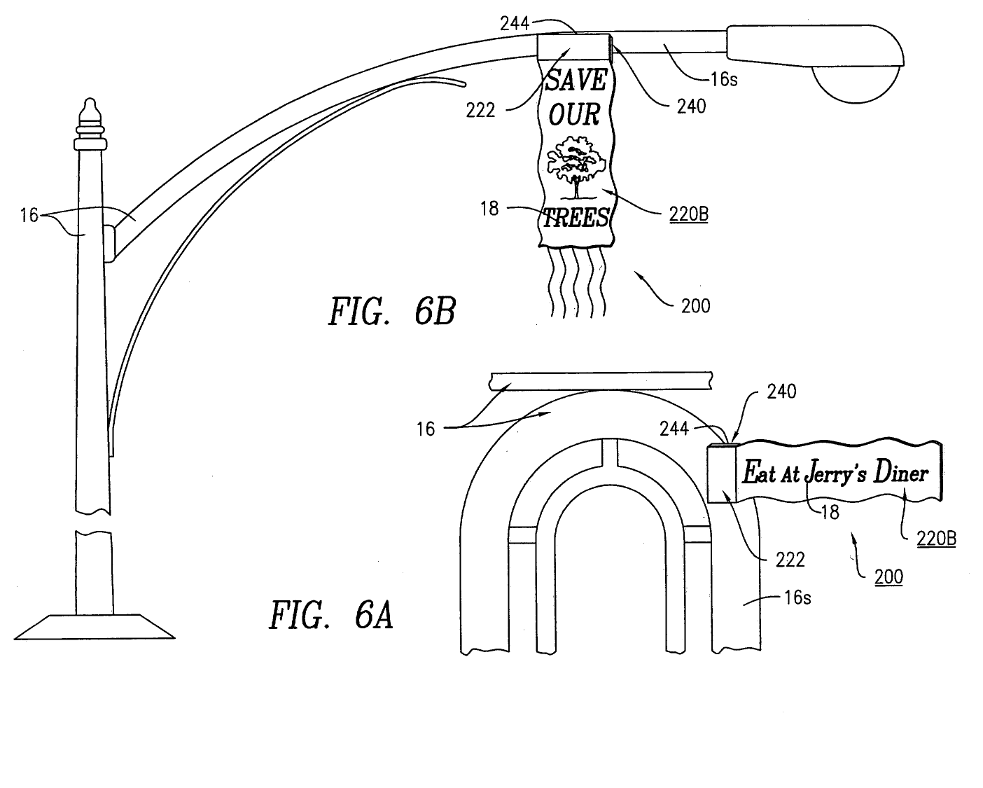

The mounting display device 200 of the third embodiment is mounted to a metal structure 16, for example a bridge or tunnel overpass (see FIG. 6A), a metal facade and a lamp post (see FIG. 6B) and the like, such that when the banner 220B is magnetically attached to the bridge structure 16 the prevailing wind will also produce a “flying banner” effect to the banner 220B attached to the bridge structure 16, as depicted in FIG. 6A of the drawings. The banner 220B can include indicia 18 for use in advertising, announcements and the like which can be easily secured and attached to such metal structures 16.

The mounting display devices 10, 100 and 200 use means for magnetically attaching the flag 20F, the pennant 120P or the banner 220B to the vehicle 12 and/or metal structure 14, 16. The means for magnetically attaching include a pair of flexible rubberized magnetic strips or magnetic members 40 and 50, or a single magnetic strip 140 or a rigid magnetic strip/bar 240. The mounting display devices 10, 100 and 200 can vary in overall size, shape, design, color and configuration depending upon its consumer/commercial use.

### First Embodiment 10

The mounting display device 10 and its component parts of the first embodiment of the present invention are represented in detail by FIGS. 1, 1A, 1B through 3 of the patent drawings. The mounting display device 10 is used in conjunction with a flag 20F having a pair of magnetic strips 40 and 50 thereon for mounting the device 10 on to any type of vehicle 12, such as cars (see FIG. 1B), motorcycles, pick-up trucks, vans (see FIG. 1A), SUVs, buses, RVs, tractor-trailers, car trailers and other magnetic surfaces so as to also hang the display device 10 vertically. The flag 20F, as shown in FIGS. 1 to 3, includes a mounting section 22 positioned at the proximal end 24 of flag 20F. The mounting section 22 includes a first mounting section contact side or first mounting side 26, a second mounting section contact side or second mounting side 28 and perimeter edges 30a, 30b, 30c and 30d. Flag 20F can have a geometric configuration selected form the group consisting of a square, a rectangle, a triangle, a semi-circle and a

polygon. The mounting section 22 has a substantially rectangular shape. The flag 20F and mounting section 22 can be made from materials such as cotton, rayon, nylon, polyester, linen, felt, wool and combinations thereof.

The first magnetic strip 40 includes a first contact surface 42, a second contact surface 44 and perimeter edges 46a, 46b, 46c and 46d. The first contact surface 42 can include securing means 48 thereon in the form of adhesives 48a, glues 48b, epoxy cements 48c, laser welding/fusing 48d, stapling 48e, stitching 48f or combinations thereof.

The second magnetic strip 50 includes a first contact surface 52, a second contact surface 54 and perimeter edges 56a, 56b, 56c and 56d. The first contact surface 52 can also include the aforementioned securing means 48 in the form of adhesives 48a, glues 48b, epoxy cements 48c, laser welding/fusing 48d, stapling 48e, stitching 48f or combinations thereof. Each of the magnetic strips 40 and 50 has a substantially rectangular shape. Magnetic strips 40 and 50 can have other geometric shapes such as a square, a rectangle, a triangle, a circle, a semi-circle, an arc shape and other polygonal shapes, or non-geometric shapes.

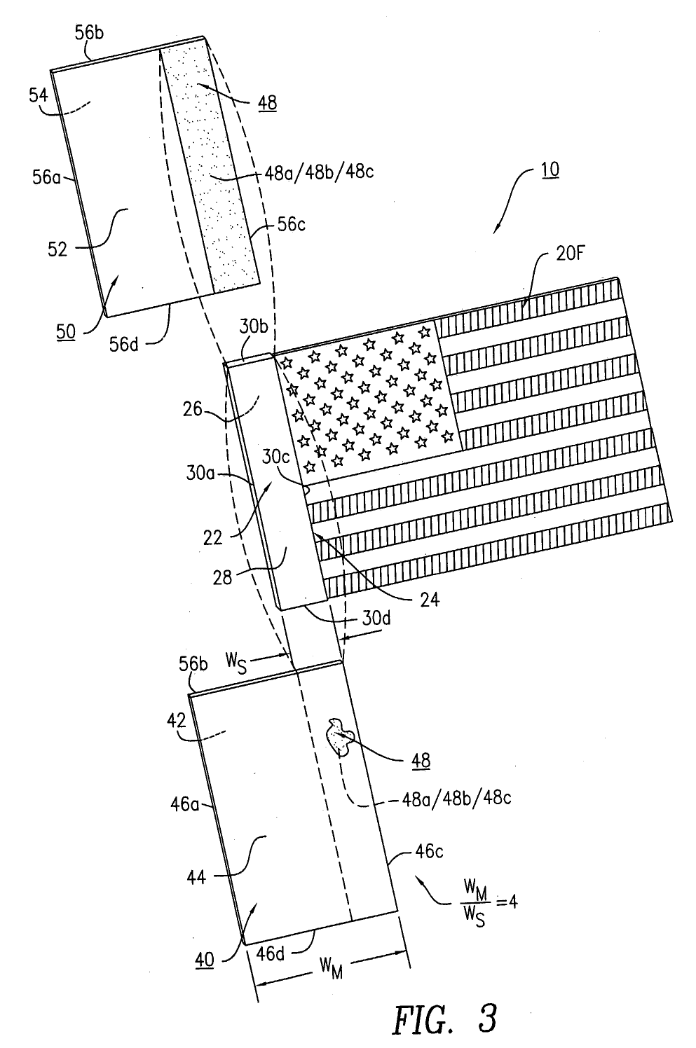

In forming the mounting display device 10, as shown in FIG. 3, a part or all of the first contact surface 42 of the first magnetic strip 40 having adhesive, glue or epoxy cement 48a, 48b or 48c, respectively, thereon is then adhered to the first mounting side 26 of mounting section 22, as defined by the perimeter edges 30a to 30d of mounting section 22, and a part of the first contact surfaces 52 of the second magnetic strip 50 having adhesive, glue or epoxy cement 48a, 48b or 48c thereon which is then adhered to the second mounting side 28 of mounting section 22, as defined by the perimeter edges 30a to 30d of mounting section 22. It is understood that the first contact surfaces 42 and 52 of magnetic strips 40 and 50, respectively, can also be adhered or joined together by laser welding/fusing, stapling or stitching or combinations thereof. The aforementioned procedure encloses and layers the mounting section 22 between each of the magnetic members 40 and 50, as depicted in FIGS. 2 and 3 of the drawings, thus forming the mounting display device 10 of the first embodiment.

Additionally, as shown in FIGS. 2 and 3, an optimum width W_{M} of the magnetic strips 40 and 50 as compared to the width W_{S} of the mounting section 22 is used for maximizing the holding strength of the magnetic strips 40 and 50 on the moving vehicle 12. This holding strength ratio of W_{M} to W_{S} has a ratio of 4:1. For example, if mounting section 22 has a width measurement W_{S} of 1 inch, the width measurement of W_{M} of magnetic strips 40 and 50 has a width measurement W_{M} of 4 inches, as depicted in FIG. 3.

### Second Embodiment 100

The mounting display device 100 and its component parts of the second embodiment of the present invention are represented in detail by FIGS. 4, 4A, 4B and 5 of the patent drawings. The mounting display device 100 is used in conjunction with a pennant 120P having a single magnetic strip/magnetic member 140 thereon for mounting the device 100 onto a metal structure 14, such as a goalpost (see FIG. 4A), a metal fence (see FIG. 4B), metal decking and the like. The pennant 120P, as shown in FIGS. 4 and 5, includes a mounting section 122 positioned at a proximal end 124 of pennant 120P. The mounting section 122 includes a first mounting side 126, a second mounting side 128 and perimeter edges 130a, 130b, 130c and 130d.

The magnetic member 140 includes a first contact surface 142, a second contact surface 144 and perimeter edges 146a, 146b, 146c and 146d. The first contact surface 142 can also include securing means 48 thereon in the form of adhesives 48a, glues 48b, epoxy cement 48c, laser welding/fusing 48d, stapling 48e, stitching 48f or combinations thereof. Magnetic member 140 has a substantially rectangular shape. Magnetic member 140 can have other geometric shapes such as a square, a rectangle, a triangle, a circle, a semi-circle, an arc shape and other polygonal shapes, or non-geometric shapes.

In forming the mounting display device 100, as shown in FIGS. 4 to 6, a part or all of the first contact surface 142 of the magnetic member 140 having securing means 48 thereon (such as staples 48e and/or stitching 48f) is then attached and connected to the first mounting side 126 of mounting section 122 of pennant 120P as defined by the perimeter edges 130a to 130d of mounting section 122. It is understood that the second contact surface 144 of magnetic member 140 can have the aforementioned securing means 48 thereon and attached/adhered to the second mounting side 128 of mounting section 12 of pennant 120P instead of using the first mounting side 126 of mounting section 122. The aforementioned procedure layers one of the mounting sides 126 or 128 of mounting section 122 to either one of the contact surfaces 142 or 144 of magnetic member 140, as depicted in FIGS. 4 and 5, thus forming the mounting display device 100 in a single continuous layered structure 102.

### Third Embodiment 200

The mounting display device 200 and its component parts of the third embodiment of the present invention are represented in detail by FIGS. 6, 6A, 6B and 7 of the patent drawings. The mounting display device 200 is used in conjunction with a banner 220B having a single, rigid magnetic strip/bar member 240 thereon for mounting the device 200 to a metal structure 16, such as a bridge overpass (see FIG. 6A), a metal facade of a building, a lamp post (see FIG. 6B) and the like. The banner 220B, as shown in FIGS. 6 and 7, includes a mounting section 222 positioned at a proximal end 224 of banner 220B. The mounting section 222 includes a first mounting side 226, a second mounting side 228 and perimeter edges 230a, 230b, 230c and 230d.

The rigid magnetic bar member 240 includes a first contact wall surface 242, a second contact wall surface 244 and perimeter edges 246a, 246b, 246c and 246d. The first contact wall surface 242 also includes securing means 48 thereon in the form of adhesives 48a, glues 48b, epoxy cements 48c, laser welding/fusing 48d or combinations thereof.

In forming the mounting display device 200, as shown in FIGS. 6 and 7, a part or all of the first contact wall surface 242 of magnetic bar member 240 includes adhesive 48a, glue 48b or epoxy cement 48c thereon is then adhered to the first mounting side 226 of mounting section 222, as defined by the perimeter edges 230a to 230d of mounting section 222. In an alternate configuration (not shown), the first contact wall surface 242 of magnetic bar member 240 is fused or laser welded 48d to the first mounting side 226 of mounting section 22, as defined by the perimeter edges 230a to 230d of mounting section 222. Also, the first contact wall surface 242 of magnetic bar member 240 can be adhered and/or fused with either of the mounting sides 226 or 228 of mounting section 222. The aforementioned procedure layers one of the mounting sides 226 or 228 of mounting section 222 to either one of the contact wall surfaces 242 or 244 of magnetic bar member 240, as depicted in FIGS. 6 and 7, thus forming the mounting display device 200 in a double layered laminated composite structure 202. Magnetic bar 240 can have other geometric shapes such as a square, a rectangle, a triangle, a circle, a semi-circle, an arc shape and other polygonal shapes, or non-geometric shapes.

### Operation of the Present Invention

In operating the mounting display devices 10, 100 and 200 of the present invention, the user simply cleans a surface area 12s on vehicle 12 or a surface area 14s or 16s on metal structures 14 or 16 in which to better adhere the contact surfaces 54, 142 or 244 of magnetic members 50, 140 or 240, respectively, to the aforementioned vehicle 12 or metal structures 14, 16. If the vehicle 12, or metal structures 14 or 16 have a curved surface 12s, 14s or 16s the magnetic members 40, 50 and 140 are flexibly received to that contoured and curved surface 12s or 14s, such that the contact surface 54 or 142 of magnetic members 50 or 140 are in full contact (flush) with surfaces 12s or 14s of vehicle 12 or metal structure 14, respectively, as depicted in FIGS. 1A, 1B, 4A and 4B. The user now simply applies and adheres the contact surfaces 54, 144 or 244 of magnetic members+ 50, 140 or 240 to the appropriate location/position on the vehicle surface 12s or metal structure surface 14s or 16s in which to detachably mount and display the flag 20F, the pennant 120P or the banner 220B appropriately on vehicle 12 or metal structures 14 or 16, as shown in FIGS. 1A, 1B, 4A, 4B, 6A and 6B of the drawings. When removing the above mounting display devices 10, 100 or 200, the user simply dislodges the contact surface 54, 142 or 244 of magnetic members 50, 140 or 240 from the surfaces 12s, 14s or 16s of the vehicle 12, or metal structures 14 or 16, respectively.

### Advantages of the Present Invention

Accordingly, an advantage of the present invention is that it provides for a mounting display device for flags, banners, pennants, ensigns, pennons, and the like having magnetic members thereon for mounting on vehicles and other metallic structures.

Another advantage of the present invention is that it provides for a mounting display device having each of the magnetic members being attached by securing means to each of the mounting section surfaces at one end of the flag.

Another advantage of the present invention is that it provides for a mounting display device that allows the magnetic members to be attached to the mounting section surfaces of the flag by securing means in the form of adhesives, glues, epoxy cements, laser welding, stapling, stitching and fusing or as a lamination in order to make the magnetic member(s) an integral part of the construction.

Another advantage of the present invention is that it provides for a mounting display device that allows the stitching of the magnetic member(s) to the flag and/or other types of displays.

Another advantage of the present invention is that it provides for a mounting display device that uses a magnetic member(s) in the form of a flexible rubberized magnetic strip(s) or a rigid magnetized bar/strip(s) for attaching to the mounting section surface(s) of the flag.

Another advantage of the present invention is that it provides for a mounting display device that allows the magnetic members to be magnetically attached to the vehicle which then produces a “flying flag” effect when the vehicle is moving.

Another advantage of the present invention is to provide a mounting display device of varying sizes, shapes, designs and configuration for use on cars, motorcycles, pick-up trucks, vans, SUVs, buses, tractor trailers, as well as for use on metal doors, ceilings and posts.

Another advantage of the present invention is that it provides for a mounting display device is capable of withstanding everyday wear and tear, easy to use and is aesthetically pleasing when mounted to the vehicle or other metal structure as well as eliminating the use of tape, wire or string to display and then remove without leaving marks or mars.

Another advantage of the present invention is that it provides an interchangeable advertising device on vehicles, store fronts and other metal structures.

A further advantage of the present invention is that it provides for a mounting display device that can be mass produced in an automated and economical manner and is readily affordable by the consumer, and used as a device to display their beliefs.

A latitude of modification, change, and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1. A mounting display device for a flag, a banner or a pennant, comprising:
a) a flag, a banner or a pennant being referred to as a flag and having a mounting section; said mounting section having a first mounting side and a second mounting side;
b) at least one magnetic member having a first contact surface and a second contact surface;
c) said first contact surface having adhesive or glue thereon for adhering to said first mounting side of said mounting section of said flag; and
d) said second contact surface of said magnetic member for magnetically attaching said flag to a vehicle or a metal structure.

2. A mounting display device in accordance with claim 1, further including a second magnetic member having a first contact surface and a second contact surface; said first contact surface of said second magnetic member having adhesive or glue thereon for adhering said second magnetic member to said second mounting side of said mounting section of said flag; and said second contact surface of said second magnetic member for magnetically attaching said flag to said vehicle or said metal structure.

3. A mounting display device in accordance with claim 1, wherein said mounting section is attached to a proximal end of said flag.

4. A mounting display device in accordance with claim 1, wherein said flag and said mounting section are made from materials selected from the group consisting of cotton, rayon, nylon, polyester, linen, felt, wool and combinations thereof.

5. A mounting display device in accordance with claim 1, wherein said magnetic member is a flexible, rubberized magnetic strip.

6. A mounting display device in accordance with claim 1, wherein said magnetic member is a rigid magnetic bar or a rigid magnetic strip.

7. A mounting display device in accordance with claim 2, wherein a part of said magnetic member includes adhesives or glue thereon for adhering to said first mounting side of said mounting section of said flag; and a part of said second magnetic member includes adhesive or glue thereon for adhering to said second mounting side of said mounting section of said flag.

8. A mounting display device in accordance with claim 7, wherein each of said magnetic members has a geometric shape selected from the group consisting of a square, a rectangle, a triangle, a circle, a semi-circle, an arc shape, and other polygonal shapes.

9. A mounting display device in accordance with claim 7, wherein each of said magnetic members has a non-geometric shape.

10. A mounting display device in accordance with claim 8, wherein each of said magnetic members has a width and length.

11. A mounting display device in accordance with claim 7, wherein said mounting section has a substantially rectangular shape and having a width and a length.

12. A mounting display device in accordance with claim 9, wherein said width of each of said magnetic members as compared to said width of said mounting section has a 4 to 1 ratio for optimizing the magnetic strength of each of said magnetic members on said vehicle or said metal structure.

13. A mounting display device for a flag, a banner or a pennant, comprising:
a) a flag, a banner or a pennant being referred to as a flag and having a mounting section;
b) said mounting section having a first mounting side and a second mounting side;
c) first means for magnetically attaching having a first contact surface and a second contact surface;
d) second means for magnetically attaching having a first contact surface and a second contact surface;
e) said first contact surface of said first means for magnetically attaching having securing means thereon for adhering to said first mounting side of said mounting section of said flag, respectively;
f) said first contact surface of said second means for magnetically attaching having said securing means thereon for adhering to said second mounting side of said mounting section of said flag, respectively; and
g) said second contact surfaces of each of said first and second means for magnetically attaching said flag to a vehicle or a metal structure.

14. A mounting display device in accordance with claim 13, wherein said mounting section is attached to a proximal end of said flag.

15. A mounting display device in accordance with claim 13, wherein said flag and said mounting section are made from materials selected from the group consisting of cotton, rayon, nylon, polyester, linen, felt, wool and combinations thereof.

16. A mounting display device in accordance with claim 13, wherein said first and second means for magnetically attaching include a flexible, rubberized magnetic member or a rigid magnetic bar.

17. A mounting display device in accordance with claim 13, wherein a part of said first means for magnetically attaching includes said securing means thereon for adhering to said first mounting side of said mounting section of said flag; and a part of said second means for magnetically attaching includes said securing means thereon for adhering to said second mounting side of said mounting section of said flag.

18. A mounting display device in accordance with claim 13, wherein said securing means includes adhesives, glues, epoxy cements, laser welding, fusing, stapling, stitching and combinations thereof.

19. A mounting display device in accordance with claim 13, wherein each of said first and second means for magnetically attaching has a geometric shape selected from the group consisting of a square, a rectangle, a triangle, a circle, a semi-circle, an arc shape, and other polygonal shapes.

20. A mounting display device in accordance with claim 13, wherein each of said first and second magnetic means for attaching has a non-geometric shape.

21. A mounting display device in accordance with claim 19, wherein each of said first and second means for magnetically attaching has a width and a length.

22. A mounting display device in accordance with claim 13, wherein said mounting section has a substantially rectangular shape and having a width and a length.

23. A mounting display device in accordance with claim 20, wherein said width of each of said first and second means for magnetically attaching as compared to said width of said mounting section has a 4 to 1 ratio for optimizing the magnetic strength of each of said first and second means for magnetically attaching on said vehicle or said metal structure.

24. A mounting display device in accordance with claim 13, wherein said flag has a geometric configuration selected from the group consisting of a square, a rectangle, a triangle, a semi-circle, and a polygon.
